(19) United States
(12) Patent Application Publication
(10) Pub. No.: US 2015/0116222 A1
(43) Pub. Date: Apr. 30, 2015

(54) KEYBOARD WITH SWAPPABLE KEYS AND KEY FUNCTIONS

(71) Applicant: LENOVO (SINGAPORE) PTE, LTD, NEW TECH PARK (SG)

(72) Inventors: Markus Takashi Heberlein, Tokyo (JP); Mamoru Okada, Kanagawa-ken (JP)

(73) Assignee: LENOVO (SINGAPORE) PTE, LTD, New Tech Park (SG)

(21) Appl. No.: 14/062,041

(22) Filed: Oct. 24, 2013

(51) Int. Cl. G06F 3/02

(52) U.S. Cl. CPC G06F 3/0216
USPC 345/168

(57) ABSTRACT

A keyboard may provide a user with a customizable keyboard layout. Keys may be moved from their default position into a new key position while retaining their indicated keystroke function. In some embodiments, two keys may be swappable so that the keystroke function associated with the first key may be moved into the keyboard position of the second key and vice versa. In some embodiments, the keyboard positions may include more than one switch to provide more than one keystroke function at keyboard positions. Key caps may be configured to actuate their corresponding indicated keystroke function by actuating one or more switches at different keyboard positions.

### BACKGROUND OF THE INVENTION

The present invention generally relates to data input hardware and, more particularly, to a keyboard with swappable keys and key functions.

Keyboards on various computing devices may provide various configurations. Typically, the keyboard layout and the respective keystroke functions of keys may be factory preset. In some computing devices, the user may access the BIOS and electronically reprogram the keystroke function for a key in a keyboard position. However, modifying the BIOS may be risky for some individuals who may not be programming savvy. Still yet, many other individuals may not even know that the BIOS exists.

Yet, customizability in keyboards may be essential for some individuals that live in areas where different languages may be prevalent and thus, certain keys and keystroke functions may be necessary to include in the keyboard. In addition, for different languages that may use common alphabets or at least include many common alphabet symbols, the keyboard layout may need customization to position letters (or symbols) for typing access based on frequency of use.

As can be seen, there is a need for providing a keyboard that can be customized according to the end user's needs.

### SUMMARY OF THE INVENTION

In one aspect of the present invention, a keyboard comprises a first key assembly positioned on a first position of the keyboard, the first key assembly configured to provide at least a first output signal corresponding to a first keystroke function; a second key assembly positioned on a second position of the keyboard, the second key assembly configured to provide the first output signal and a second output signal corresponding to a second keystroke function; a key cap configured to: activate the first keystroke function in response to actuating the first key assembly, and activate the first keystroke function in response to actuating the second key assembly.

In another aspect of the present invention, a keyboard comprises a first key cap; a second key cap; a key cap port configured to receive interchangeably, the first key cap and the second key cap; a key assembly area positioned beneath the key cap port; a first switch in the key assembly area and disposed for activation by the first key cap, the first switch configured to indicate a first keystroke function corresponding to the first key cap; and a second switch in the key assembly area and disposed for activation by the second key cap, the second switch configured to indicate a second keystroke function corresponding to the second key cap.

In yet another aspect of the present invention, a keyboard comprises a signal output layer; a first keystroke region of the signal output layer; a first switch of the first keystroke region corresponding to a first keystroke function; a second switch of the first keystroke region corresponding to a second keystroke function; a second keystroke region of the signal output layer; a first switch of the second keystroke region corresponding to the second keystroke function;

and a second switch of the second keystroke area corresponding to the first keystroke function.

These and other features, aspects and advantages of the present invention will become better understood with reference to the following drawings, description and claims.

### BRIEF DESCRIPTION OF THE DRAWINGS

FIG. 1 is a block diagram of a computing system according to an exemplary embodiment of the present invention;

FIGS. 2A and 2B are partial top views of keyboard keys exchanging keyboard positions according to an exemplary embodiment of the present invention;

FIGS. 3A and 3B are cross-sectional side views of key assemblies of the keyboard of FIG. 2 at different positions according to an exemplary embodiment of the present invention; and

FIG. 4 is a cross-sectional side view of a key assembly according to another exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides a keyboard with keys that may retain their indicated key function but at different positions of the keyboard. A user may customize the configuration of his or her keyboard to place key functions in positions that may be more user-friendly or compatible with the frequency of use in the user's native language.

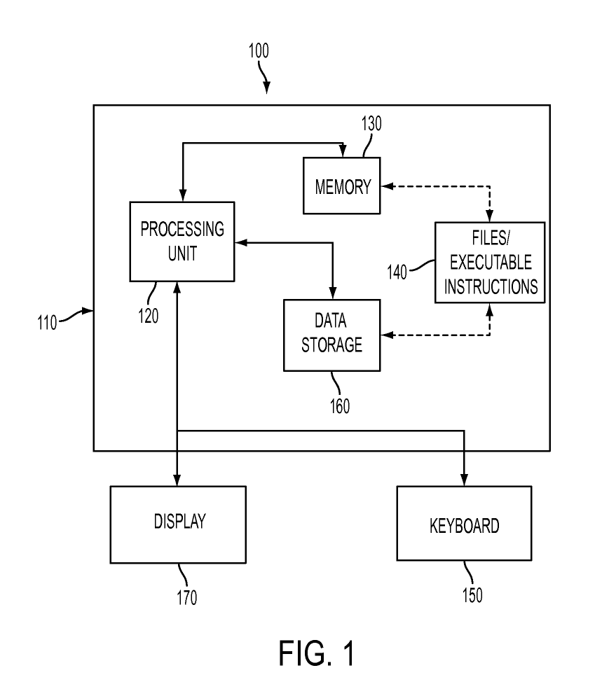

Referring now to FIG. 1, a computing system 100 is shown in accordance with an exemplary embodiment of the present invention. The computing system 100 may include an input device 110 and a keyboard 150. The input device 110 may be, for example, a desktop computer, a laptop or notebook computer, a tablet, or a mobile telephone. The input device 110 may be coupled to a display 170 configured to display data provided by input generated by the keyboard 150. The input device 110 may include a processing unit 120, a memory module 130, and a data storage module 160. The memory module 130 and the data storage module 160 may be in the form of non-transitory computer readable media configured to store files and executable instructions 140.

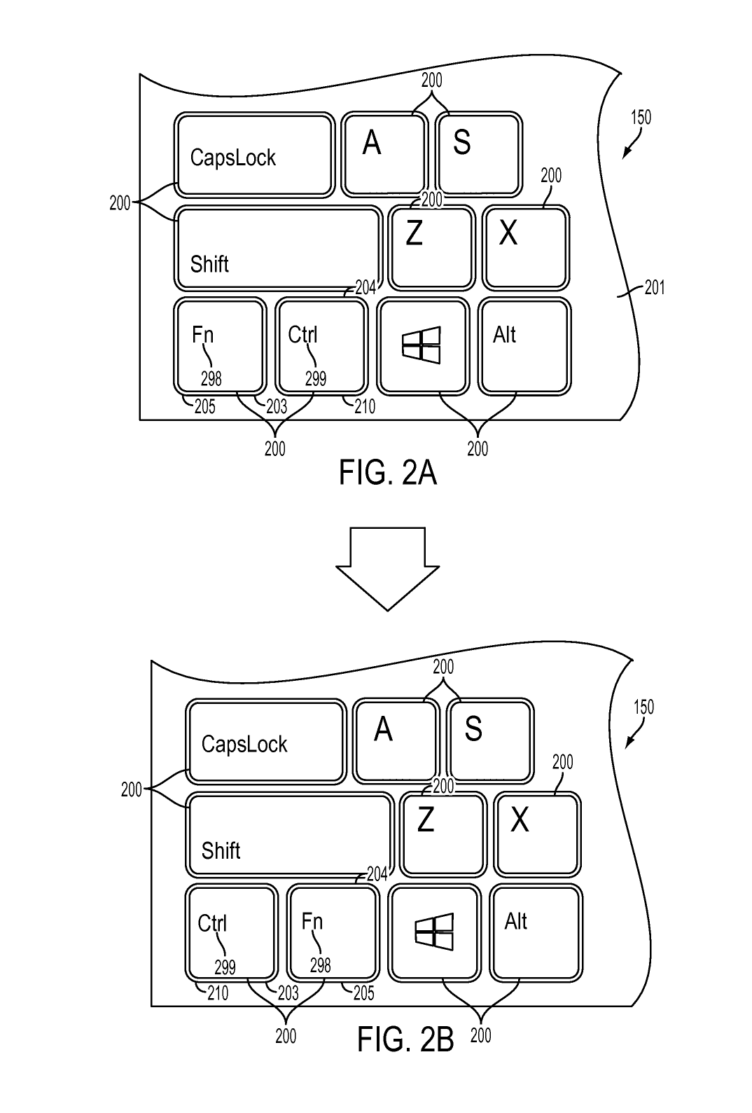

Referring now to FIGS. 2A and 2B, partial views of the keyboard 150 show different states according to an exemplary embodiment of the present invention. The keyboard 150 may include keys 200 positioned within a frame 201. In an exemplary embodiment, a key cap 205 and a key cap 210 may be interchangeable or swapped between different key positions, such as key position 203 and key position 204. The key cap 205 may include indicia 298. The indicia 298 may indicate a keystroke function associated with depression of the key cap 205. For example, in FIG. 2A, the indicia 298 may indicate that pressing the key cap 205 may activate a “function” (abbreviated as “Fn”) command. The key cap 210 may include indicia 299 which may indicate, for example, a “control” (abbreviated as “Ctrl”) command. While the “Fn” and “Ctrl” keys are described as examples, it will be understood that other key functions or types (for example, letters) may be used under exemplary embodiments of the present invention. The key caps 205 and 210 may be swappable by the user so that, in FIG. 2B, the key cap 205 and its corresponding function may be moved from key position 203 to key position 204; and the key cap 205 may retain its corresponding function in key position 204. For example, the “Fn” key may be removed by a user from key position 203 and moved by the user to key position 204. The key cap 210 and its corresponding function may be moved from the key position 204 to the key position 203. Thus, the “Ctrl” function may move from the key position 204 to the key position 203. While the foregoing has been described in terms of swapping or exchanging the positions of two key caps 205 and 210 while retaining their respective functions in their new positions, it will be understood that some embodiments may involve exchanging positions between more than two keys 200.

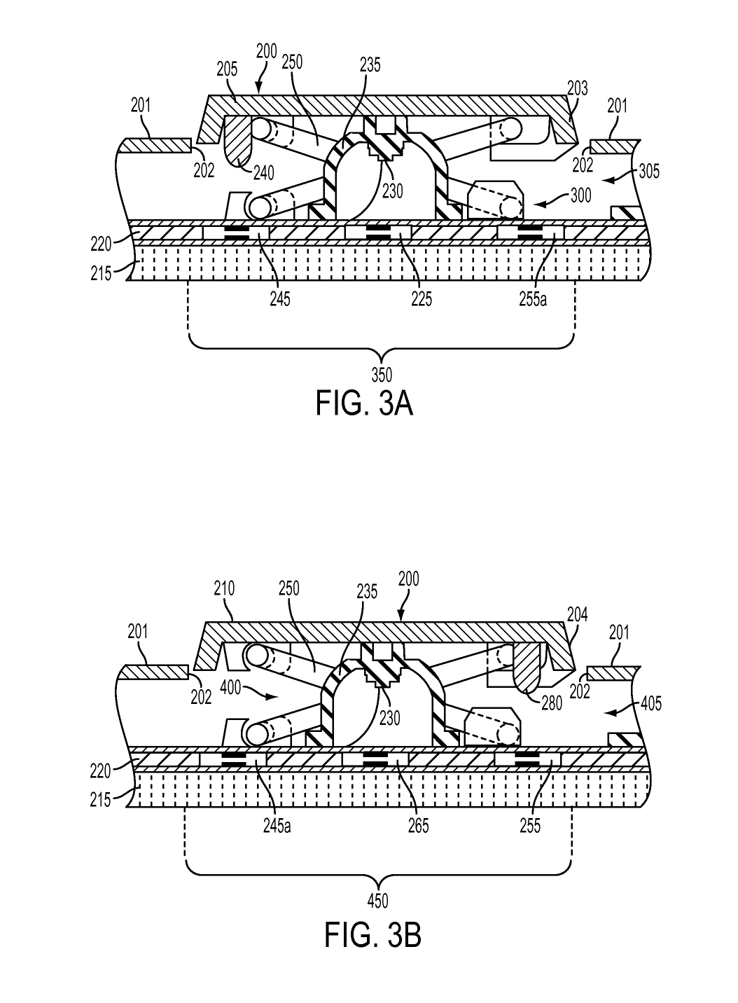

Referring now to FIGS. 3A and 3B, key assemblies 300 and 400 are shown according to exemplary embodiments of the present invention. In FIG. 3A, the key cap 205 is shown in position 203 and operable to actuate the key assembly 300. In FIG. 3B, the key cap 210 is shown in position 204 and operable to actuate the key assembly 400. The key cap 205 and the key cap 210 may move within key ports 202 formed in the keyboard frame 201, and also be removed by the user from the key ports 202. A keyboard base 215 and a keyboard output signal layer 220 may be coupled to the keys 200. The output signal layer 220 may be, for example, a printed circuit board which may provide a keystroke function signal associated with respective keys 200 to the input device 110 (FIG. 1) when one or more of the keys 200 are actuated.

The following describes operation of the key assemblies 300 and 400—with the key cap 205 as part of the key assembly 300 and the key cap 210 as part of the key assembly 400. However, it will be understood that a user may move the key cap 205 into a key position, such as 204, that is part of the key assembly 400. Likewise, a user may move the key cap 210 into a key position, such as 203, that is part of the key assembly 300 as described above.

In an exemplary embodiment, the key assembly 300 may provide more than one potential keystroke function depending on which key cap (such as 205 or 210) is in a particular keyboard position (such as 203). For example, the key assembly 300 may provide at least a first output signal corresponding to a first keystroke function (for example, the “Fn” command) when a first key cap (such as 205) is in a selected position (such as 203). In some embodiments, the key assembly 300 may also provide a second output signal corresponding to a second keystroke function (for example, the “Ctrl” command) when a second key cap (such as 210) is in the selected position (such as 203).

In FIG. 3A, a key assembly area 305 may support the key caps (such as 205 or 210) in movement between a default state and a depressed state. The key assembly area 305 may include, for example, a rubber dome 235 and a pantograph 250 providing a spring bias in actuation of the key cap 205. The key assembly area 305 may include a keystroke region 350 of the output signal layer 220 which may include at least two switches 225 and 245. In some embodiments, the keystroke region 350 may include a third switch 255a in the output signal layer. The keystroke region 350 may be beneath the key cap (such as 205 or 210).

Actuation of respective switches (225, 245, or 255a) may invoke different keystroke functions. For example, the switch 225 may be a primary switch which may correspond to a default keystroke function programmed for keyboard position 203. The switch 225 may be actuated for example by a projection 230 centered in the rubber dome 235 and pushed down into contact with the switch 225 when the key assembly 300 is pressed. In some embodiments, a default key cap (such as 205) may be the default key 200 for the keyboard position 203. Depression of the default key cap (such as 205) may actuate the default keystroke function associated with the keyboard position 203 by triggering the switch 225.

In some embodiments, an alternate key cap (such as 205) may provide an alternate keystroke function for the keyboard position 203 (or the keyboard position 204). The alternate key cap (such as 205) may include a projection 240 on its underside (FIG. 3A). The projection 240 may be on a left side of the key cap 205 (from the perspective of a user operating the keyboard 150 (FIG. 1). When the alternate key cap (such as 205) is in the keyboard position (such as 203), the projection 240 may be positioned over the switch 245. The switch 245 may be a secondary switch so that actuation of the key assembly 300 may push the projection 240 into contact with the switch 245, and thus invoking the alternate keystroke function associated with keyboard position 203. In some embodiments, the switch 255a whose actuation may provide a third keystroke function for keyboard position 203 may remain dormant until a key cap with a projection positioned over the switch 255a is in keyboard position 203.

In some embodiments, a keystroke function associated with the key cap 205 in the keyboard position 203 may be actuated by the output signal layer registering contact of both the switch 225 and the switch 245 simultaneously. For example, the depression of the key cap 205 may provide contact of the switch 225 by the projection 230 and may provide contact of the switch 245 by the projection 245.

In an exemplary embodiment, as shown in FIG. 3B, the key assembly 400 may provide more than one potential keystroke function depending on which key cap (such as 205 or 210) is in a selected keyboard position (such as 204). For example, the key assembly 400 may provide a first output signal corresponding to a first keystroke function (for example, the “Ctrl” command) when the key cap 210 may be in position 204. In some embodiments, the key assembly 400 may also provide a second output signal corresponding to a second keystroke function (for example, the “Fn” command) when the key cap 205 may be in position 204. A key assembly area 405 may support the key caps 205 or 210 in movement between a default state and a depressed state. The key assembly area 405 may be similar to the key assembly 305 except that the key cap 210 may include a projection 280 on its right hand underside. The key assembly area 405 may include a keystroke region 450 of the output signal layer 220 which may include at least two switches 255 and 265. In some embodiments, the keystroke region 350 may include a third switch 245a in the output signal layer. The keystroke region 450 may be beneath the key cap 205 or the key cap 210 when either is positioned in keyboard position 204.

In FIG. 3B, actuation of respective switches (245a, 255, or 265) may invoke different keystroke functions. For example, the switch 265 may be a primary switch which may correspond to a default keystroke function programmed for keyboard position 204. The switch 265 may be actuated for example by the projection 230 centered in the rubber dome 235 and pushed down into contact with the switch 265 when the key assembly 400 is pressed. In some embodiments, a default key cap (such as 210) may be the default key 200 for the keyboard position 204. Depression of the default key cap (such as 210) may actuate the default keystroke function associated with the keyboard position 204 by triggering the switch 265.

In some embodiments, an alternate key cap (such as 210) may provide an alternate keystroke function for the keyboard position 204 (or the keyboard position 203). When the alternate key cap (such as 210) is in the keyboard position (such as 203), the projection 280 may be positioned over the switch 255. The switch 255 may be a secondary switch so that actuation of the key assembly 400 may push the projection 280 into contact with the switch 255, and thus invoking the alternate keystroke function associated with keyboard position 204. In some embodiments, the switch 245a whose actuation may provide a third keystroke function for keyboard position 204 may remain dormant until a keycap with a projection positioned over the switch 245a is in keyboard position 204.

In some embodiments, a keystroke function associated with the key cap (such as 210) in the keyboard position (such as 204) may be actuated by the output signal layer registering contact of two switches, simultaneously, such as both the switch 255 and the switch 265, simultaneously. For example, the depression of the key cap 210 may provide contact of the switch 265 by the projection 230 and may provide contact of the switch 255 by the projection 280.

In some embodiments, a keystroke function, may be programmed into or associated with switches in different keystroke regions. For example, the “Fn” command may be actuated by either the switch 245 in the key assembly 300 or by the switch 245a in the key assembly 400. Thus, use of the “Fn” command may be customized by the user on the keyboard 150 (FIG. 1) by using the key cap 205 in the keyboard position 203 or the keyboard position 204 since the projection 240 may contact the switch 245 in the keyboard position 203 and the projection 240 may contact the switch 245a in the keyboard position 204. The “Ctrl” function may be actuated by either the switch 255 in the key assembly 400 or the switch 255a in the key assembly 300. Thus, use of the “Ctrl” command on the keyboard 150 (FIG. 1) may be customized, for example, by using the key cap 210 in either the keyboard position 203 or the keyboard position 204 since the projection 280 may contact the switch 255a in the keyboard position 203 or contact the switch 255 in the keyboard position 204.

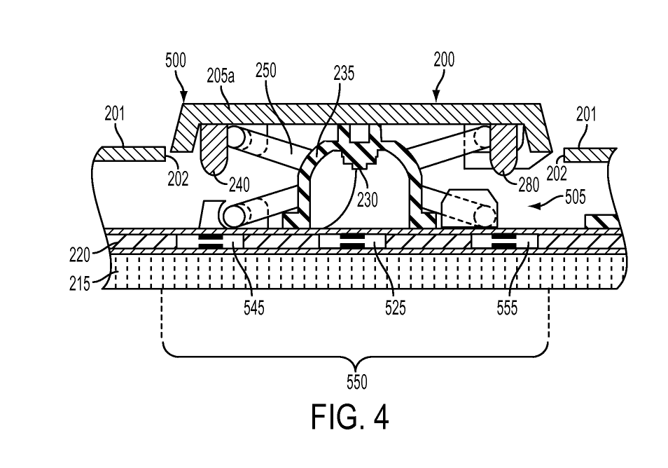

Referring now to FIG. 4, a key assembly 500 is shown in accordance with an exemplary embodiment of the present invention. The key assembly 500 may include a projection 240 on the left underside and a projection 280 on the right underside of a key cap 205. In some embodiments, the key cap 205a may be used in conjunction with the key caps 205 and 210 so that three keystroke functions may be interchangeable on the keyboard 150 (FIG. 1). The key assembly area 505 is similar to the key assembly areas 305 and 405 except for the aforementioned key cap 205a. The keystroke region 550 may include the switches 525, 545, and 555 whose individual or combined activation may invoke one or more keystroke functions. The use of projections 240 and 280 on the key cap 205a may provide for simultaneous contact of three switches (525, 545, and 555) which may provide, for example, a third keystroke function for the key 200. Additional keystroke function combinations may be available for the key assembly 500 by offsetting the projection 240 from the projection 280 so that the projection 240 is on a different lateral plane (not shown) from the projection 280 and, thus, the projections 240 and 280 may not necessarily contact the switches 545 and 555 simultaneously.

It should be understood, of course, that the foregoing relates to exemplary embodiments of the invention and that modifications may be made without departing from the spirit and scope of the invention as set forth in the following claims.

We claim:

1. A keyboard, comprising:
a first key assembly positioned on a first position of the keyboard, the first key assembly configured to provide at least a first output signal corresponding to a first keystroke function;
a second key assembly positioned on a second position of the keyboard, the second key assembly configured to provide the first output signal and a second output signal corresponding to a second keystroke function;
a key cap configured to:
activate the first keystroke function in response to actuating the first key assembly, and
activate the first keystroke function in response to actuating the second key assembly.

2. The keyboard of claim 1, wherein the key cap is a first key cap, the keyboard further comprising a second key cap configured to:
activate the second keystroke function in response to actuating the second key assembly, and
activate the second keystroke function in response to actuating the first key assembly.

3. The keyboard of claim 2, further comprising:
a primary switch and a secondary switch of the first key assembly, wherein said primary switch is configured to trigger the first keystroke function and said secondary switch is configured to trigger the second keystroke function; and
a primary switch and a secondary switch of the second key assembly, wherein said primary switch is configured to trigger the second keystroke function and said secondary switch is configured to trigger the first keystroke function.

4. The keyboard of claim 2, wherein the first key cap and the second key cap both fit into either a first key cap port over the first key assembly or a second key cap port over the second key assembly.

5. A keyboard, comprising:
a first key cap;
a second key cap;
a key cap port configured to receive interchangeably, the first key cap and the second key cap;
a key assembly area positioned beneath the key cap port;
a first switch in the key assembly area and disposed for activation by the first key cap, the first switch configured to indicate a first keystroke function corresponding to the first key cap; and
a second switch in the key assembly area and disposed for activation by the second key cap, the second switch configured to indicate a second keystroke function corresponding to the second key cap.

6. The keyboard of claim 5, further comprising a first projection coupled to the first key cap, said projection disposed to contact the first switch in response to depression of the first key cap.

7. The keyboard of claim 6, further comprising a second projection coupled to the second key cap, said projection disposed to contact the second switch in response to depression of the second key cap.

8. The keyboard of claim 7, further comprising a rubber dome, wherein the first switch is positioned underneath the rubber dome and the second switch is positioned outside the rubber dome.

9. The keyboard of claim 5, further comprising a third switch in the key assembly area and coupled to the signal output layer, the third switch disposed for activation by depression of a third key cap, the third switch configured to indicate a third keystroke function corresponding to the third key cap.

10. The keyboard of claim 5, wherein the first key cap represents a “Ctrl” key and the second key cap represents a “Fn” key.

11. A keyboard, comprising:
a signal output layer;
a first keystroke region of the signal output layer;
a first switch of the first keystroke region corresponding to a first keystroke function;
a second switch of the first keystroke region corresponding to a second keystroke function;
a second keystroke region of the signal output layer;
a first switch of the second keystroke region corresponding to the second keystroke function; and
a second switch of the second keystroke area corresponding to the first keystroke function.

12. The keyboard of claim 11, further comprising a first removable key cap configured to interchangeably couple to either the first keystroke region or the second keystroke region.

13. The keyboard of claim 12, wherein the first removable key cap is configured to activate the first switch in the first keystroke region and activate the second switch in the second keystroke region.

14. The keyboard of claim 13, further comprising a second removable key cap configured to interchangeably couple to either the first keystroke region or the second keystroke region.

15. The keyboard of claim 14, wherein the second removable key cap is configured to activate the second switch in the first keystroke region and activate the first switch in the second keystroke region.

16. The keyboard of claim 13, further comprising a first projection coupled to the first removable key cap, said projection disposed to contact the second switch of the second keystroke region in response to depression of the first removable key cap over the second keystroke region.

17. The keyboard of claim 16, further comprising a second projection coupled to the second removable key cap, said projection disposed to contact the second switch of the first keystroke region in response to depression of the second removable key cap over the first keystroke region.

18. The keyboard of claim 16, wherein the first switch in the first keystroke region is configured to activate a default keystroke function corresponding to indicia represented on the first removable key cap.

19. The keyboard of claim 18, wherein the second switch in the first keystroke region is configured to activate an alternate keystroke function corresponding to indicia represented on the second removable key cap.

20. The keyboard of claim 11, further comprising a third switch of the first keystroke region, the third switch corresponding to a third keystroke function.
